(19) United States
(12) Patent Application Publication
(10) Pub. No.: US 2024/0318330 A1
(43) Pub. Date: Sep. 26, 2024

(54) ELECTROCHEMICAL CELL

(71) Applicant: NGK INSULATORS, LTD., Nagoya-shi (JP)

(72) Inventors: Naoya AKIYAMA, Nagoya-shi (JP); Toshiyuki NAKAMURA, Handa-shi (JP); Makoto OHMORI, Nagoya-shi (JP)

(21) Appl. No.: 18/616,626

(22) Filed: Mar. 26, 2024

Related U.S. Application Data
(63) Continuation of application No. PCT/JP2023/011859, filed on Mar. 24, 2023.

(51) Int. Cl. C25B 11/032; C25B 1/042; C25B 9/23; C25B 11/037; C25B 11/042

(52) U.S. Cl. CPC C25B 11/032; C25B 1/042; C25B 9/23; C25B 11/037; C25B 11/042

(57) ABSTRACT

An electrochemical cell includes a metal substrate and a cell body. The metal substrate has: a gas-permeable region in which a plurality of connecting holes are formed; and a non-gas-permeable region surrounding the gas-permeable region in a plan view. The cell body is disposed on the metal substrate. The cell body has: a first electrode layer containing Ni; a second electrode layer; and an electrolyte layer disposed between the first electrode layer and the second electrode layer. The first electrode layer has a first region formed on the gas-permeable region, and a second region formed on the non-gas-permeable region. A mean particle diameter of Ni contained in the second region is smaller than a mean particle diameter of Ni contained in the first region.

### CROSS-REFERENCE TO RELATED APPLICATION

This is a continuation application of PCT/JP2023/011859, filed on Mar. 24, 2023, the entire contents of which are hereby incorporated by reference.

### TECHNICAL FIELD

The present invention relates to an electrochemical cell.

### BACKGROUND ART

Electrochemical cells (electrolytic cells, fuel cells etc.) are conventionally known that have a metal substrate and a cell body disposed on the metal substrate (e.g. see JP 2020-155337A).

The metal substrate includes a gas-permeable region in which a plurality of connecting holes are formed, and a non-gas-permeable region surrounding the gas-permeable region in a plan view.

The cell body has a first electrode layer formed on the metal substrate, a second electrode layer, and an electrolyte layer disposed between the first electrode layer and the second electrode layer. The first electrode layer has a first region formed on the gas-permeable region of the metal substrate, and a second region formed on the non-gas-permeable region of the metal substrate.

### SUMMARY

When a stack of a plurality of electrochemical cells is used, the second region of the first electrode layer is located on the side where a side face of the stack is present. Thus, the temperature of the second region is likely to drop due to heat dissipation to the outside air, and it is difficult for a gas to be supplied from the connecting holes to the second region. Therefore, the electrode reaction is less likely to occur in the second region than in the first region, thus causing a current distribution between the first region and the second region and making the first electrode layer likely to deteriorate.

An object of the present invention is to provide an electrochemical cell capable of preventing deterioration of the first electrode layer.

An electrochemical cell according to a first aspect of the present invention includes a metal substrate and a cell body. The metal substrate has: a gas-permeable region in which a plurality of connecting holes are formed; and a non-gas-permeable region surrounding the gas-permeable region in a plan view. The cell body is disposed on the metal substrate. The cell body has: a first electrode layer containing Ni; a second electrode layer; and an electrolyte layer disposed between the first electrode layer and the second electrode layer. The first electrode layer has a first region formed on the gas-permeable region, and a second region formed on the non-gas-permeable region. A mean particle diameter of Ni contained in the second region is smaller than a mean particle diameter of Ni contained in the first region.

An electrochemical cell according to a second aspect of the present invention is the electrochemical cell of the first aspect, wherein a porosity of the second region is greater than a porosity of the first region.

According to the present invention, it is possible to provide an electrochemical cell capable of preventing deterioration of the first electrode layer.

### BRIEF DESCRIPTION OF DRAWINGS

FIG. 1 is a plan view of an electrolytic cell according to an embodiment.

FIG. 2 shows an A-A cross-section of FIG. 1.

### DESCRIPTION OF DRAWINGS

### Electrolytic Cell 1

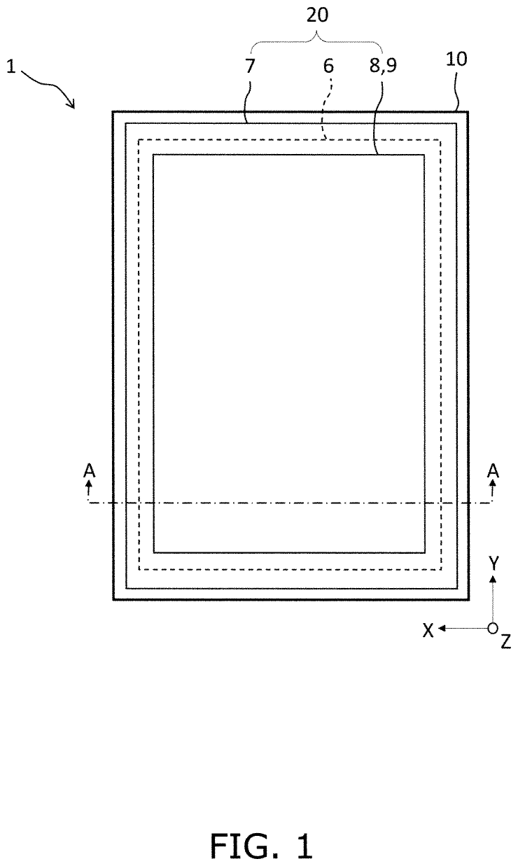

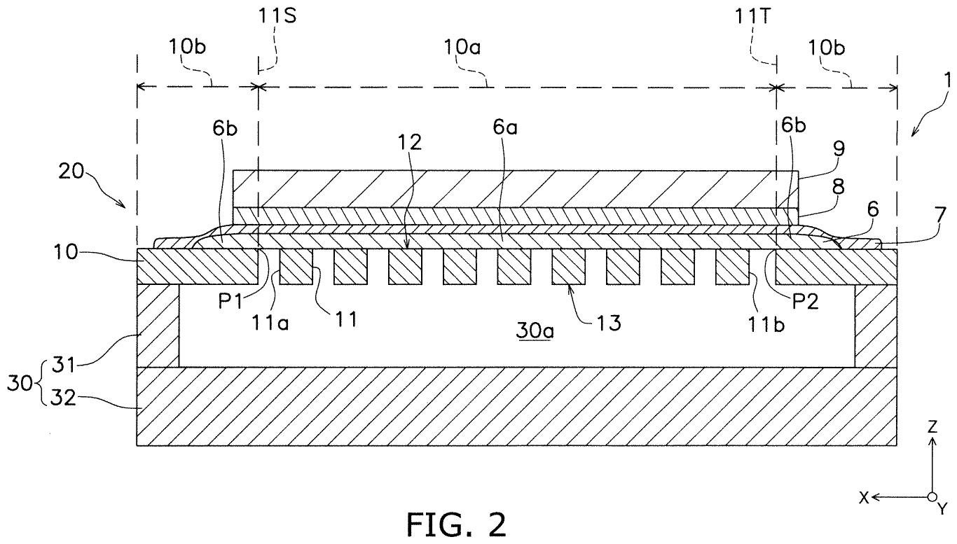

FIG. 1 is a plan view of an electrolytic cell 1 according to an embodiment. FIG. 2 shows an A-A cross-section of FIG. 1. The electrolytic cell 1 is an example of an “electrochemical cell” according to the present invention.

The electrolytic cell 1 has a plate shape expanding in an X-axis direction and a Y-axis direction. The electrolytic cell 1 in the present embodiment has a rectangular shape elongated in the Y-axis direction in a plan view. However, the shape of the electrolytic cell 1 in the plan view is not specifically limited, and may alternatively be other than a rectangular shape, and may be a polygonal shape, an elliptic shape, a circular shape, or the like. Note that each of the X-axis direction and the Y-axis direction is an example of a surface direction.

As shown in FIG. 2, the electrolytic cell 1 includes a metal substrate 10, a cell body 20, and a channel member 30.

### Metal Substrate 10

The metal substrate 10 supports the cell body 20. The metal substrate 10 has a plate shape. The metal substrate 10 may have a flat plate shape or a curved plate shape. The metal substrate 10 need only be capable of supporting the cell body 20. The thickness of the metal substrate 10 is not specifically limited, but may be, for example, 0.1 mm or more and 2.0 mm or less.

As shown in FIG. 2, the metal substrate 10 has a plurality of connecting holes 11, a first principal surface 12, and a second principal surface 13.

Each connecting hole 11 extends through the metal substrate 10 from the first principal surface 12 to the second principal surface 13. Each connecting hole 11 is open in the first principal surface 12 and the second principal surface 13. The opening of each connecting hole 11 in the first principal surface 12 is covered by a hydrogen electrode layer 6. The opening of each connecting hole 11 in the second principal surface 13 is continuous with a later-described channel 30a.

The connecting holes 11 can be formed by means of mechanical processing (e.g. punching), laser processing, chemical processing (e.g. etching), or the like. In the case where the metal substrate 10 is made of porous metal, the connecting holes 11 may be formed by openings of the porous metal that are connected to each other. The connecting holes 11 may be perpendicular to the first primary surface 12, but need not be perpendicular to the first primary surface 12, and need not be straight.

The cell body 20 is joined to the first principal surface 12. The channel member 30 is joined to the second principal surface 13. The first principal surface 12 is provided on the opposite side to the second principal surface 13.

As shown in FIG. 2, the metal substrate 10 includes a gas-permeable region 10a and a non-gas-permeable region 10b. The gas-permeable region 10a is a region in which the plurality of connecting holes 11 are formed in the metal substrate 10. The non-gas-permeable region 10b is a region in the metal substrate 10 other than the gas-permeable region 10a. The non-gas-permeable region 10b surrounds the gas-permeable region 10a in a plan view from the Z-axis direction perpendicular to the X-axis direction and the Y-axis direction. Thus, the non-gas-permeable region 10b appears on both sides of the gas-permeable region 10a in a cross section of the metal substrate 10 along the Z-axis direction, as shown in FIG. 2.

As shown in FIG. 2, the boundary between the gas-permeable region 10a and the non-gas-permeable region 10b is defined by openings of first and second connecting holes 11a and 11b, which are located on the outermost sides in the X-axis direction. Specifically, the boundary between the gas-permeable region 10a and the non-gas-permeable region 10b is defined by a first reference line 11S and a second reference line 11T. The first reference line 11S is a straight line that passes through an outermost position P1, in the X-axis direction, of an opening on the first primary surface 12 side of the first supply hole 11a located at an outermost position in the X-axis direction, and is parallel to the Z-axis direction (i.e. perpendicular to the first principal surface 12 in FIG. 2). The second reference line 11T is a straight line that passes through an outermost position P2, in the X-axis direction, of an opening on the first primary surface 12 side of the second supply hole 11b farthest from the first supply hole 11a in the X-axis direction, and is parallel to the Z-axis direction (i.e. perpendicular to the first principal surface 12 in FIG. 2). The gas-permeable region 10a is a region between the first reference line 11S and the second reference line 11T in the metal substrate 10, and the non-gas-permeable region 10b is a region in the metal substrate 10 excluding the gas-permeable region 10a, i.e. a region including portions on both sides of the gas-permeable region 10a.

The metal substrate 10 is made of a metallic material. The metal substrate 10 is, for example, made of an alloy material containing Cr (chromium). Examples of such metallic materials include Fe—Cr alloy steel (stainless steel etc.) and Ni—Cr alloy steel. The content of Cr in the metal substrate 10 is not specifically limited, but can be 4% by mass or more and 30% by mass or less.

The metal substrate 10 may also contain Ti (titanium) and/or Zr (zirconium). The content of Ti in the metal substrate 10 is not specifically limited, but can be 0.01 mol % or more and 1.0 mol % or less. The content of Al in the metal substrate 10 is not specifically limited, but can be 0.01 mol % or more and 0.4 mol % or less. The metal substrate 10 may contain Ti in the form of TiO₂ (titania) and may contain Zr in the form of ZrO₂ (zirconia).

The metal substrate 10 may have, on a surface thereof, an oxide film formed by oxidation of constituent elements of the metal substrate 10. A typical oxide film is, for example, a chromium oxide film. The chromium oxide film covers at least a portion of the surface of the metal substrate 10. The chromium oxide film may also cover at least a portion of an inner wall surface of each connecting hole 11.

### Cell Body 20

The cell body 20 is disposed on the metal substrate 10. The cell body 20 has a hydrogen electrode layer 6 (cathode), an electrolyte layer 7, a reaction-preventing layer 8, and an oxygen electrode layer 9 (anode).

The hydrogen electrode layer 6, the electrolyte layer 7, the reaction-preventing layer 8, and the oxygen electrode layer 9 are stacked in this order from the metal substrate 10 side in a Z-axis direction perpendicular to the X-axis direction and the Y-axis direction. The hydrogen electrode layer 6, the electrolyte layer 7, and the oxygen electrode layer 9 are essential components, and the reaction-preventing layer 8 is an optional component.

### Hydrogen Electrode Layer 6

The hydrogen electrode layer 6 is formed on the metal substrate 10. The hydrogen electrode layer 6 is disposed between the metal substrate 10 and the electrolyte layer 7. The hydrogen electrode layer 6 is supported by the metal substrate 10. Specifically, the hydrogen electrode layer 6 is disposed on the first principal surface 12 of the metal substrate 10. The hydrogen electrode layer 6 is an example of a “first electrode layer” according to the present invention.

The source gas is supplied to the hydrogen electrode layer 6 via the connecting holes 11. The source gas contains at least H₂O.

When the source gas contains only H₂O, the hydrogen electrode layer 6 produces H₂ from the source gas in accordance with the electrochemical reaction of water electrolysis expressed by the following chemical equation (1).

$$Hydrogen electrode layer 6 : {H}_{2} O + 2 {e}^{-} \to {H}_{2} + {O}^{2 -} \qquad ( 1 )$$

When the source gas contains CO₂ in addition to H₂O, the hydrogen electrode layer 6 produces H₂, CO, and O²⁻ from the source gas in accordance with the electrochemical reaction of co-electrolysis expressed by the following chemical equations (2), (3), and (4).

$$Hydrogen electrode layer 6 : {CO}_{2} + {H}_{2} O + 4 {e}^{-} \to CO + {H}_{2} + 2 {O}^{2 -} \qquad ( 2 )$$

$$Electrochemical reaction of {H}_{2} O : {H}_{2} O + 2 {e}^{-} \to {H}_{2} + {O}^{2 -} \qquad ( 3 )$$

$$Electrochemical reaction of {CO}_{2} : {CO}_{2} + 2 {e}^{-} \to CO + {O}^{2 -} \qquad ( 4 )$$

The hydrogen electrode layer 6 is an electrically conductive porous body. The hydrogen electrode layer 6 contains nickel (Ni). In the case of co-electrolysis, Ni functions not only as an electron-conductive material but also as a thermal catalyst to promote the thermal reaction between H₂ produced and CO₂ contained in the source gas and maintain a gas composition appropriate for methanation, reverse water-gas shift reactions, or the like. Ni contained in the hydrogen electrode layer 6 basically exists in the state of metallic Ni during the operation of the electrolytic cell 1, but a part of Ni may exist in the state of nickel oxide (NiO).

The hydrogen electrode layer 6 may contain an ion-conductive material. The ion-conductive material can be YSZ, CSZ, ScSZ, GDC, SDC, (La, Sr) (Cr, Mn)O₃, (La, Sr)TiO₃, Sr₂(Fe, Mo)₂O₆, (La, Sr)VO₃, (La, Sr)FeO₃, LDC (Lanthanum Doped Ceria), LSGM (Lanthanum Gallate), or a mixed material of two or more of these materials.

The Ni content in the hydrogen electrode layer 6 is not specifically limited, but can be 20 vol % or more and 50 vol % or less. The Ni content is calculated by the following method. First, a cross section of the hydrogen electrode layer 6 along the Z-axis direction is exposed. Next, a composition mapping image of Ni in the cross section of the hydrogen electrode layer 6 is acquired at a magnification of 5000 to 10000 times, using a SEM device (manufactured by JEOL Ltd., FE-SEM JSM-7900F) and an EDS device (JED-2300) attached to the SEM device. Next, Ni particles are identified in the composition mapping image of Ni by performing binarization processing through image analysis, using image analysis software Image-Pro manufactured by MEDIACYBERNETICS. Then, the Ni content in the hydrogen electrode layer 6 is calculated by dividing the total area of the Ni particles by the total area of the hydrogen electrode layer 6 (including the pores) in a backscattered electron image.

The content of the ion-conductive material in the hydrogen electrode layer 6 is not specifically limited, but can be 20 vol % or more and 50 vol % or less. The content of the ion-conductive material is calculated by the following method. First, a composition mapping image of an element whose content is largest among the constituent elements of the ion-conductive material in the cross section of the hydrogen electrode layer 6 (hereinafter referred to as a “largest-content element”) is acquired at a magnification of 5000 to 10000 times, using the aforementioned SEM device and EDS device. Next, particle portions of the largest-content element are identified in the composition mapping image of the largest-content element by performing binarization processing through image analysis, using the aforementioned image analysis software Image-Pro. Then, the content of the ion-conductive material in the hydrogen electrode layer 6 is calculated by dividing the total area of the particle portions of the largest-content element by the total area of the hydrogen electrode layer 6 (including the pores) in a backscattered electron image.

The thickness of the hydrogen electrode layer 6 is not specifically limited, but can be, for example, 1 μm or more and 100 μm or less.

As shown in FIG. 2, the hydrogen electrode layer 6 includes a first region 6a and a second region 6b. The first region 6a is a region in the hydrogen electrode layer 6 that is formed on the gas-permeable region 10a of the metal substrate 10. The second region 6b is a region in the hydrogen electrode layer 6 that is formed on the non-gas-permeable region 10b of the metal substrate 10. The second region 6b surrounds the first region 6a in a plan view from the Z-axis direction. Thus, the second region 6b appears on both sides of the first region 6a in a cross section of the hydrogen electrode layer 6 along the Z-axis direction, as shown in FIG. 2.

The boundary between the first region 6a and the second region 6b is defined by the aforementioned first reference line 11S and second reference line 11T. The first region 6a is a region between the first reference line 11S and the second reference line 11T in the hydrogen electrode layer 6, and the second region 6b is a region in the hydrogen electrode layer 6 excluding the first region 6a, i.e. a region including portions on both sides of the first region 6a.

Here, since the mean particle diameter of Ni contained in the second region 6b is smaller than the mean particle diameter of Ni contained in the first region 6a, the activity of Ni contained in the second region 6b is higher than that of Ni contained in the first region 6a. This can improve the electrode activity in the second region 6b, where the temperature is more likely to decrease than in the first region 6a due to heat dissipation and where the source gas is less likely to be supplied from the connecting holes 11. It is therefore possible to reduce the difference in electrode activity between the first region 6a and the second region 6b, and to prevent the occurrence of a current distribution between these two regions, thereby preventing deterioration of the hydrogen electrode layer 6.

Conventionally, the H₂ production rate in the second region 6b is likely to be low and the H₂O concentration is likely to be high since the temperature drop caused by heat dissipation lowers the electrode activity. An increase in the H₂O concentration raises the growth rate of the oxide film on the surface of the metal substrate 10, making it difficult for a current to flow through the second region 6b, and resulting in a greater current distribution. In the present embodiment, the electrode activity can be improved by reducing the mean particle diameter of Ni in the second region 6b. As a result, the H₂ production rate is maintained, and the current distribution can therefore be prevented from becoming larger.

Note that, in the electrolytic cell 1 in which an endothermic reaction occurs, the temperature of the second region 6b is likely to decrease, unlike a fuel cell in which an exothermic reaction occurs. Further, in the electrolytic cell 1, the function of Ni as a thermal catalyst can be improved by reducing the mean particle diameter of Ni. Accordingly, the aforementioned effect is particularly effective in the electrolytic cell 1.

The mean particle diameter of Ni contained in the first region 6a is not specifically limited, but can be 3 μm or more and 10 μm or less. The mean particle diameter of Ni contained in the second region 6b is not specifically limited, but can be 1 μm or more and 7 μm or less.

The mean particle diameter of Ni contained in the first region 6a is calculated by the following method. First, a cross section of the hydrogen electrode layer 6 along the Z-axis direction is exposed. Next, Ni mapping images of the first region 6a at five locations at which the first region 6a is evenly divided into six parts in the thickness direction are acquired at a magnification of 5000 to 10000 times, at three locations, namely at a position on the first connecting hole 11a, a position on the second the connecting hole 11b, and the center of the first region 6a in the surface direction, using a SEM device (manufactured by JEOL Ltd., FE-SEM JSM-7900F) and an EDS device (JED-2300) attached to the SEM device. As a result, 15 Ni mapping images are acquired. Next, Ni particle portions are identified in the Ni mapping images by performing binarization processing through image analysis, using image analysis software Image-Pro manufactured by MEDIACYBERNETICS. As a result, 15 Ni analysis images are acquired. Next, in each of the binarized analysis images, the diameter of a circle having the same area as the area of each Ni particle is acquired as the particle diameter of each Ni particle. Then, the mean particle diameter of Ni contained in the first region 6a is calculated by taking an arithmetic mean of the particle diameters of Ni acquired from the 15 analysis images.

Note that the term “thickness direction” as used herein refers to a direction perpendicular to a surface direction, which is parallel to the first principal surface 12 of the metal substrate 10. The thickness direction is identified by using an approximate straight line of the first principal surface 12 obtained by the least square method in a cross section of the metal substrate 10 along the Z-axis direction.

The mean particle diameter of Ni contained in the second region 6b is calculated by the same method as the method for calculating the mean particle diameter of Ni contained in the first region 6a. However, Ni mapping images of the second region 6b at five locations at which the second region 6b is evenly divided into six parts in the thickness direction are acquired at two locations at which each of the portions of the second region 6b on the respective sides of the first region 6a is evenly divided into three parts in the surface direction. Accordingly, 20 Ni mapping images are used to calculate the mean particle diameter of Ni contained in the second region 6b. The 20 Ni mapping images are acquired on the cross section of the hydrogen electrode layer 6 that is used to calculate the mean particle diameter of Ni contained in the first region 6a.

It is preferable that the porosity of the second region 6b is greater than the porosity of the first region 6a. This can improve the gas diffusion properties in the second region 6b where the source gas is less likely to be supplied from the connecting holes 11, thereby further improving the electrode reaction in the second region 6b. It is therefore possible to further prevent the occurrence of a current distribution between the first region 6a and the second region 6b, and thus further prevent deterioration of the first electrode layer 6.

The porosity of the first region 6a is not specifically limited, but can be 20% or more and 40% or less. The porosity of the second region 6b is not specifically limited, but can be 25% or more and 50% or less.

The porosity of the first region 6a is calculated by the following method. First, a cross section of the hydrogen electrode layer 6 along the Z-axis direction is exposed. Next, a backscattered electron image of the cross section of the first region 6a is acquired at a magnification of 10000 times using the aforementioned SEM device. Next, portions displayed in black (which correspond to the pores) in the backscattered electron image are identified using image analysis software Image-Pro, manufactured by MEDIACYBERNETICS. Then, the porosity of the first region 6a is calculated by dividing the total area of the pores by the total area of the backscattered electron image of the first region 6a.

The porosity of the second region 6b is calculated by dividing the total area of the pores by the total area of the backscattered electron image of the second region 6b, similarly to the porosity of the first region 6a.

The hydrogen electrode layer 6 is produced by forming the first region 6a on the metal substrate 10 using the constituent material for the first region, and thereafter forming the second region 6b surrounding the first region 6a using the constituent material for the second region. The method of forming the first and second regions 6a and 6b is not specifically limited, and may be a sintering method, a spray coating method (thermal spray method, aerosol deposition method, aerosol gas deposition method, powder jet deposition method, particle jet deposition method, cold spray method etc.), a PVD method (sputtering method, pulsed laser deposition method etc.), a CVD method, or the like.

### Electrolyte Layer 7

The electrolyte layer 7 is disposed between the hydrogen electrode layer 6 and the oxygen electrode layer 9. In the present embodiment, the reaction-preventing layer 8 is disposed between the electrolyte layer 7 and the oxygen electrode layer 9, and the electrolyte layer 7 is therefore disposed between the hydrogen electrode layer 6 and the reaction-preventing layer 8, and is connected to the hydrogen electrode layer 6 and the reaction-preventing layer 8.

The electrolyte layer 7 covers the hydrogen electrode layer 6 and also covers a region of the first principal surface 12 of the metal substrate 10 that is exposed from the hydrogen electrode layer 6.

The electrolyte layer 7 transmits O²⁻ produced in the hydrogen electrode layer 6 toward the oxygen electrode layer 9. The electrolyte layer 7 is made of an oxide ion-conductive dense material. The electrolyte layer 7 can be made of, for example, YSZ (yttria stabilized zirconia; e.g. 8YSZ), GDC (gadolinium doped ceria), ScSZ (scandia stabilized zirconia), SDC (samarium solid solution ceria), LSGM (lanthanum gallate), or the like.

The porosity of the electrolyte layer 7 is not specifically limited, but can be, for example, 0.1% or more and 7% or less. The thickness of the electrolyte layer 7 is not specifically limited, but can be, for example, 1 μm or more and 100 μm or less.

The method of forming the electrolyte layer 7 is not specifically limited, and can be a sintering method, a spray coating method, a PVD method, a CVD method, or the like.

### Reaction-Preventing Layer 8

The reaction-preventing layer 8 is disposed between the electrolyte layer 7 and the oxygen electrode layer 9. The reaction-preventing layer 8 is disposed on the opposite side to the hydrogen electrode layer 6 with respect to the electrolyte layer 7. The reaction-preventing layer 8 prevents a constituent element of the electrolyte layer 7 from reacting with a constituent element of the oxygen electrode layer 9 to form a layer with high electrical resistance.

The reaction-preventing layer 8 is constituted by an oxide ion-conductive material. The reaction-preventing layer 8 can be made of GDC, SDC, or the like.

The porosity of the reaction-preventing layer 8 is not specifically limited, but can be, for example, 0.1% or more and 50% or less. The thickness of the reaction-preventing layer 8 is not specifically limited, but can be, for example, 1 μm or more and 50 μm or less.

The method of forming the reaction-preventing layer 8 is not specifically limited, and can be a sintering method, a spray coating method, a PVD method, a CVD method, or the like.

### Oxygen Electrode Layer 9

The oxygen electrode layer 9 is disposed on the opposite side to the hydrogen electrode layer 6 with respect to the electrolyte layer 7. In the present embodiment, the reaction-preventing layer 8 is disposed between the electrolyte layer 7 and the oxygen electrode layer 9, and the oxygen electrode layer 9 is therefore connected to the reaction-preventing layer 8. If the reaction-preventing layer 8 is not disposed between the electrolyte layer 7 and the oxygen electrode layer 9, the oxygen electrode layer 9 is connected to the electrolyte layer 7. The oxygen electrode layer 9 is an example of a “second electrode layer” according to the present invention.

The oxygen electrode layer 9 produces 02 from 02-transmitted from the hydrogen electrode layer 6 via the electrolyte layer 7, in accordance with the chemical reaction expressed by the following chemical equation (5).

$$Oxygen electrode layer 9 : 2 {O}^{2 -} \to {O}_{2} + 4 {e}^{-} \qquad ( 5 )$$

The oxygen electrode layer 9 is made of an oxide ion-conductive and electron-conductive porous material. The oxygen electrode layer 9 can be made of, for example, a composite material of an oxide ion-conductive material (GDC etc.) and at least one of (La, Sr)(Co, Fe)O₃, (La, Sr)FeO₃, La(Ni, Fe)O₃, (La, Sr)CoO₃, and (Sm, Sr)CoO₃.

The porosity of the oxygen electrode layer 9 is not specifically limited, but can be, for example, 20% or more and 60% or less. The thickness of the oxygen electrode layer 9 is not specifically limited, but can be, for example, 1 μm or more and 100 μm or less.

The method of forming the oxygen electrode layer 9 is not specifically limited, and can be a sintering method, a spray coating method, a PVD method, a CVD method, or the like.

### Channel Member 30

The channel member 30 is joined to the second principal surface 13 of the metal substrate 10. The channel member 30 forms a channel 30a between the channel member 30 and the metal substrate 10. The source gas is supplied to the channel 30a. The source gas supplied to the channel 30a is supplied to the hydrogen electrode layer 6 of the cell body 20 via the connecting holes 11 in the metal substrate 10.

The channel member 30 can be made of an alloy material, for example. The channel member 30 may be made of the same material as the metal substrate 10. In this case, the channel member 30 may be substantially integrated with the metal substrate 10.

The channel member 30 has a frame 31 and an interconnector 32. The frame 31 is an annular member that surrounds the sides of the channel 30a. The frame 31 is joined to the second principal surface 13 of the metal substrate 10. The interconnector 32 is a plate-shaped member for electrically connecting an external power source or another electrolytic cell to the electrolytic cell 1 in series. The interconnector 32 is joined to the frame 31.

The frame 31 and interconnector 32 in the present embodiment are separate members, but the frame 31 and interconnector 32 may alternatively be an integrated member.

### Variations of Embodiment

Although the embodiment of the present invention has been described above, the present invention is not limited thereto, and various changes can be made without departing from the gist of the invention.

### Variation 1

The gas diffusion layer 6 may be partially located within the connecting holes 11 of the metal substrate 10. Note that the first region 6a of the hydrogen electrode layer 6 described in the above embodiment is a region in the hydrogen electrode layer 6 that is formed on the gas-permeable region 10a of the metal substrate 10. Therefore, the regions of the hydrogen electrode layer 6 that are located in the connecting holes 11 are not included in the second region 6b of the hydrogen electrode layer 6.

### Variation 2

In the above-described embodiment, the mean particle diameter of Ni contained in the second region 6b is smaller than the mean particle diameter of Ni contained in the first region 6a, in a cross section of the hydrogen electrode layer 6. It is preferable that this configuration can be observed in all cross sections of the hydrogen electrode layer 6, but the configuration need only be able to be observed in at least one cross section of the hydrogen electrode layer 6. This is because, if the configuration can be observed in at least one cross section, deterioration of the hydrogen electrode layer 6 can be prevented at least at the corresponding location.

### Variation 3

In the above embodiment, the electrolytic cell 1 has been described as an example of an electrochemical cell. However, the electrochemical cell is not limited to an electrolytic cell. The term “electrochemical cell” is a general term for elements in which a pair of electrodes are disposed such that electromotive force is generated from the overall redox reaction in order to convert electrical energy to chemical energy, and elements for converting chemical energy into electrical energy. Accordingly, electrochemical cells include, for example, fuel cells that use oxide ions or protons as carriers.

### REFERENCE SIGNS LIST

1 Electrolytic cell
10 Metal substrate
11 Connecting hole
12 First principal surface
13 Second principal surface
20 Cell body
6 Hydrogen electrode layer
7 Electrolyte layer
8 Reaction-preventing layer
9 Oxygen electrode layer
30 Channel member
30a Channel

1. An electrochemical cell comprising:
a metal substrate having: a gas-permeable region in which a plurality of connecting holes are formed; and a non-gas-permeable region surrounding the gas-permeable region in a plan view; and
a cell body disposed on the metal substrate,
the cell body having:
a first electrode layer containing Ni;
a second electrode layer; and
an electrolyte layer disposed between the first electrode layer and the second electrode layer,
the first electrode layer having a first region formed on the gas-permeable region, and a second region formed on the non-gas-permeable region, and
a mean particle diameter of Ni contained in the second region is smaller than a mean particle diameter of Ni contained in the first region.

2. The electrochemical cell according to claim 1, wherein
a porosity of the second region is greater than a porosity of the first region.

3. The electrochemical cell according to claim 1, wherein
the first electrode layer is a hydrogen electrode configured to produce H from a source gas containing H₂O.
